(19) United States
(12) Patent Application Publication
(10) Pub. No.: US 2003/0069844 A1
(43) Pub. Date: Apr. 10, 2003

(54) Transaction handling methods and systems

(75) Inventor: Roni Koren, Maccabim (IL)

Correspondence Address: FISH & NEAVE, 1251 AVENUE OF THE AMERICAS, 50TH FLOOR, NEW YORK, NY, 10020-1105, US

(73) Assignee: CoDial Inc., Wilmington, DE (US)

(21) Appl. No.: 09/816,634

(22) Filed: Mar. 23, 2001

Related U.S. Application Data
(60) Provisional application No. 60/191,454, filed on Mar. 23, 2000.

(51) Int. Cl. G06F 17/60

(52) U.S. Cl. 705/40; 705/39; 705/26

(57) ABSTRACT

A transaction handling system automatically executes of transactions for users. The system includes a database of information of users that are registered with the system and information for transactions that are registered with the system. The system may assign a transaction code to registered transactions and may assign a user identification code to registered users. A user may request a transaction by sending a communication to the system that comprises a transaction code and the user's identification code to request a transaction.

### CROSS-REFERENCE TO RELATED APPLICATION

This claims the benefit of U.S. Provisional Patent Application No. 60/191,454, filed Mar. 23, 2000, which is hereby incorporated herein by reference in its entirety.

### BACKGROUND OF THE INVENTION

The present invention relates to electronic transaction processing systems and methods and particularly to systems and methods for executing transaction orders using a telephone or other communications terminals.

Users and businesses are currently using the Internet and other computer networks for executing on-line transactions using existing e-commerce methods. These known methods usually involve using browser software on a computer to enter a web site, searching for a desired transaction and executing the transaction using an interface provided by the computer's hardware and software.

Printed or displayed matter (like newspapers, magazines, public signs, TV screens or other displays) may continue to be used as a method of communication among businesses and users. These media may be likely to continue to be used by users who do not have computer or Internet access, users who do not have sufficient knowledge of computers and the Internet, and also by users who have access to and experience in computers and the Internet.

Sometimes executing a transaction using a computer network such as the Internet is not optimal or non-applicable to the situation involved or to the user involved. For example, to execute a transaction using a computer network, a user will have move to the location of a computer, power the computer to turn the computer on, implement browser software, enter an address for a Web site, etc.

Executing transactions (e.g., buying a product or paying a bill) that originate from reading or watching printed or displayed media content (e.g., a magazine advertisement) is possible today. One known method that is commonly used involves a user making a telephone call to a telephone number and talking to a human agent. The conversation includes the user giving the agent his or her information (e.g., name, credit card number, mailing address, etc.) and the desired transaction information (e.g., the magazine advertisement details, the desired product, the advertised price, etc.).

This technique has several shortcomings. First, a human-agent-operated service involves high cost for the operating business in providing salaries for the agents, providing office space, and paying high telephone bills. Second, the security of an executed transaction may be problematic because a stolen or lost credit card can be used by an impostor for performing the transaction. Furthermore, in such situations the impostor may ask that the goods be sent to any address causing an irreversible financial damage to the vendor and/or to the credit card company.

Third, potential customers can be reluctant to use this method because customers may not want to give private information such as name and credit card number over the telephone because of security reasons. This reluctance may be especially true when a user is performing a transaction over a cellular telephone, or at a public telephone.

Fourth, some potential customers may not finish executing a transaction using the above method because it may not be quick enough for the customer. Customers may not finish the transaction due to busy telephone lines, the relatively long durations of conversations with a human agent, etc.

Fifth, the number of simultaneous transactions a vendor using a human-operated call center can handle using the above method is limited by the number of agents and by the relatively long duration of human telephone conversations between agents and users.

Another existing method for executing similar transactions involves using voice menu systems that guide the user through voice menus to enter his or her information (e.g., name, credit card number, etc.) and to specify the desired transaction (e.g., product, price, etc.) using additional voice menus. This method is deficient in that the user is burdened to dial many different numbers (for example, a 16 digit credit card number may have to be entered) and the user may be burdened to go through many different voice menus in order to define and execute the desired transaction. These burdens may deter potential users from using this method. Some users may start a transaction, but may abort the process before completing the transaction because of the burdens described.

Other methods of making telephone transactions involve cellular telephones and SMS (Short Messaging Service). These methods also have several shortcomings. First, not all telephone network systems and telephone sets can be used for receiving and sending SMS messages (landline telephones for example are not suitable for this application). Second, sending an SMS message by a cellular telephone involves many keystrokes and is not sufficiently user-friendly for many potential users.

### SUMMARY OF THE INVENTION

In accordance with the principles of the present invention, a transaction handling system and method are provided that handle transactions quickly. The transaction handling system is adapted to receive simple instructions (e.g., a communication comprising instructions) from users and to quickly complete transactions based on the instructions.

The transaction handling system may register available transactions and assign a transaction code to each available registered transaction. Registration may include recording vendor information, product information, pricing information, information for receiving bill payments, etc. A particular available transaction and assigned transaction code may be publicized to inform users of the availability of the transaction on the system. In some embodiments, the transaction code may contain fewer than ten characters.

Users may be registered and may be assigned an identification code or number. Registration may involve recording one or more communications addresses from which the user may access the system, recording billing information of a user, recording shipping information of a user, etc. If desired, unique identification codes may be assigned to allow the system to identify the user and the user's account based on the identification code. In some embodiments, the identification code may not be a unique code in the system. In such situation, an identification code may be used in combination with other parameters to identify the user and the user's account. Other parameters may include the user's Social Security number, the user's telephone numbers, etc. Other parameters may also include voice recognition, the recognition of a spoken word, the determination that user access is from a communications address that the user registered with the system, etc. Combinations of such parameters may also be used. The identification code may be a personal identification code (e.g., a code that is personal to the registered user).

An identification code may be assigned to a user by the system when the user registers with the system. In some embodiments, the user may be permitted to select a desired identification code and the system may assign the desired identification code to the user. In other embodiments, a user may initially be assigned a provisional identification code to be able to initially access the system. The provisional identification code may be replaced with a permanent identification code when a user selects a desired identification code and the system assigns an identification code to the user based on the desired identification code (e.g., assigns the desired identification code to the user as the user's permanent identification code). The system may include precautions that may prohibit users from selecting certain codes that are commonly used (e.g., the code “1111” may be prohibited).

The transaction handling system may accept a communication comprising the transaction code and the identification code sent by a user to pursue a transaction. Acceptance may involve identifying that the user is a legitimate user of the system by checking the database of registration information. The system may identify the user and the user's account based on the identification code. Other parameters may also be used individually, in combination with the identification codes, or in any suitable combination to identify a user. If desired, the system may determine the communications address from which the communication was sent to compare that address to the registration information of users. The system may use a detected address and an identification code to identify the user and the user's account. The system may confirm that the user desires that particular transaction by for example, prompting the user to select a number (e.g., dial “1”). To cancel the order, the system may allow the user to simply hang up or disconnect.

The system may arrange for the transaction to be completed when the communication is accepted. The system may communicate with a vendor, a financial institution facility, or both to arrange a transaction to be completed. The system may communicate with the vendor or financial institution using any suitable form of communication such as electronic communications, paper communications, voice communications, etc. Communications with vendors may comprise sufficient information to allow the vendor to execute the transaction (e.g., allow the vendor to identify the goods or services, ship the goods, provide the services, etc.). Communications with financial institutions may comprise sufficient information to allow a financial institution to execute the responsibilities of the financial institution in the transaction (e.g., clear the transaction for completion, transfer payment from a user's account to a vendor's account, etc.). If desired, the system may arrange transactions without the system having to communicate with a financial institution. For example, information for executing the responsibilities of a financial institution may be communicated to a vendor and the vendor may forward such information to a financial institution. Information for a financial institution may include information on a user's account (e.g., user's account registered for making payments), user's name, the vendor's account (e.g., vendor's account registered for receiving payments), vendor's name, etc.

If desired, in some embodiments, the system may complete the transaction when the communication is accepted. The system may bill the financial account of the user based on information in the database and may ship or provide the products or services for the transaction based on the shipping information of the user. In these embodiments where the system is completing the transaction, the system may also be a system that the vendor is providing to customers to allow the vendor's goods or services to be available to customers (e.g., directly available from a vendor).

If desired, once a user is registered on the system, the user may be permitted to register transactions that are available from the user. Available transactions from the user may each be assigned a transaction code. Thus, the system may allow a registered user to request to complete a registered transaction on the system and allow a registered user to register transactions that are available from the user.

If desired, a vendor may register with the system. Once a vendor is registered, the registered vendor may complete transactions that are requested by registered users and may request to complete registered transactions on the system that are available from the system. To allow a vendor, to request registered transaction, information that is substantially the same that is information that is recorded for the users who seek to use the system may be recorded.

The system may comprise a plurality of functional blocks for handling transactions (e.g., automatically handling transactions). The system may comprise a registration processor for assigning codes and registering transactions and users, a transaction processor for accepting communications that order transactions and for arranging the completion of transactions. The system may further comprise any or all of a user communications interface, a vendor communications interface, a communications utility handler, a database, a voice analyzer, a financial institution communications interface, a user locator, etc. The system may be provided on a number of platforms such as a personal computer, a workstation, a server, a portable computer, etc.

The transaction handling system and method may enable quick and easy generation of transaction orders from practically any type of user terminal such as a telephone (cellular, landline, DTMF, etc.), computers, PDA, etc. Transactions may be requested using user terminals when a user is reading or watching a display such as printed or displayed matter on newspapers, magazines, public signs, TV screens or other visual presentations. The printed or displayed matter may include dedicated transaction codes, each code defining a specific transaction that may be executed. In some embodiments, transaction codes that each define a specific transaction have to be made available on printed or displayed matter to allow user to be informed of the availability of transactions.

A user may input a communications address for accessing the system (e.g., a telephone access number) and enter a specific-transaction code and a personal identification code or personal identification number (PIN) to request the transaction. Thus a user may efficiently and rapidly obtain execution of a specific transaction order with no need for human agent interaction and no need for the user to select from tedious menus or-enter many keystrokes on a telephone or keyboard. As will be appreciated, the user input of an access number, a specific-transaction code and a PIN, as well as any other input may be entered by keying, dialing, scanning, recognizing a user's voice or by another suitable data entry method.

As mentioned above, a user may be required to register to be eligible to use such transaction handling systems and methods. In one embodiment involving telephonic communications, the process may start with a user reading a printed matter (for example, a user may be reading a magazine advertising a specific product). The user may enter the system by dialing an access number, which may be included on the printed matter. An advantage of this system using telephonic communications is that a user reading printed media may order a transaction simply by reaching for a telephone. This alleviates the user from the cumbersome procedures that may be involved in using a computer to execute transactions (e.g., move to the location of a computer, turn on computer, etc.).

By dialing the above number, the user is connected to the transaction handling system, which may also be sometimes referred to as a transaction code handling system. The system may then prompt the user to enter (e.g., dial) the desired transaction code appearing on the printed or displayed matter and be prompted to enter (e.g., dial) his PIN. The user may be required to use a data entry key such as a particular key of a telephone (e.g., “#” key) to indicate to the system that the user has completed entering a code or PIN. The transaction code and corresponding transaction (for example, code 246 for buying the advertised product for a certain price) may be provided in the printed or displayed matter. The system hardware and software may identify the user by the caller identification (“Caller ID” or automatic number identification “ANI”) of the telephone number that he called from (which is stored in the system's database when the users registers with the service) and by his pre-assigned PIN. In cases where the system is not able to determine the identity of the calling telephone number or communications address, a user may be required to enter additional information such as the user's home telephone number or Social Security number. The system may identify the desired transaction by the dialed transaction code. The system may send the user a voice message or a displayed alphanumeric message depending on the type of user terminal to confirm that the user was identified and that the desired transaction order was identified and will be executed after the user's approval or confirmation (e.g., by dialing 1 for example).

By approving or confirming the order, the user initiates the execution of the transaction order. The system may generate a specific transaction order that may include the user's details, the vendor's details and the transaction details. The specific transaction order may be sent by the system (via the Internet or via another communications system or by mail) to the vendor of the goods or service (for example, a product retailer) who may also be registered with the system. The specific transaction order may be a document that is sent on paper or electronic media to an appropriate vendor. If desired, the order may also be sent to a financial institution for transferring payment and if desired, the order may be sent to a user to possibly confirm the transaction.

The sequence in which the transaction handling process occurs may vary to suit different communications configurations (e.g., in some systems, the user's transaction order comprising a communication may be entered first before connecting or accessing the system). These variations are all embodiments within the scope of the present invention.

Upon receiving the specific transaction order, the vendor may send the goods or data to the user's registered address that was recorded by the system when the user registered with the system. If desired, there may be more than one shipping address and a user may select one of the addresses for shipping.

The system may be compatible with a number of different user terminals, compatible with a number of different communications networks from which a user requests transactions, compatible with a number of different communications protocols in communications networks from which communications are sent, etc.. For example, the system may receive and process a communication from a registered user that uses a cellular telephone in a cellular communications network that uses a cellular communications network and receive and process another communication from another registered user that uses a landline telephone in a public switched telephone network that uses a public switched telephone network communications protocol. The system receive the communications through another communications network in between, or may have a substantially direct connection to each of those communications networks that may each use a different communications protocol.

The payment method for transactions for a user may be pre-defined. The payment method may be defined when a user registers to use the system. In one embodiment, payment may be provided using the user's assigned credit card. Information for the transaction may be transferred to the credit card company via the Internet. In other embodiments, dedicated computer networks or some other type of network may be used to transfer payments. In other embodiments, payment can be made by other billing systems (e.g., a cellular provider), financial institutions (e.g., the user's bank) or a combination thereof (e.g., small amount transactions are paid through a communications provider and larger transactions through a credit card company).

In other embodiments, the billing can be done outside of the system using the payment information sent by the user to the vendor. The vendor may then communicate with the financial institution using dedicated methods and systems (e.g., when payment transfer is being conducted external to the transaction handling system).

If desired, the system may receive a user's spoken voice that provides a transaction code and user identification code. The system may identify the user based on recognizing the user identification code when a user speaks in a voice communication to communicate with the system to request a transaction (e.g., recognize the identification code using techniques that do not rely on the characteristics of a particular user's voice. In some other embodiments, a signature (e.g., a voice signature) may be recorded for a user that includes the user speaking the user identification code during registration of the user. A user identification code spoken later may be compared to recorded signatures and a user may be identified based on the comparison. The system may automatically arrange to complete the transaction based on identifying the user to be a legitimate user and based on a transaction code that may have been spoken or entered using key entry. The system may register a voice signature of a user that may comprise a particular word selected by the user at registration. For example, the user may select his or her name. When a user desires to access the system, the user may speak that word in a communication with the system. The system may compare the spoken word with registered voice signatures to recognize the user. In some embodiments, the system may use both the user's voice and a spoken word to identify the user. The system may use the recognition of a spoken identification code (e.g., recognition of a spoken identification code irrespective of a particular user is speaking) the recognition of a particular user's voice (e.g., voice signature), or combinations thereof to recognize or identify a user. Special mechanisms may be provided within the system for voice recognition and voice signature.

Transaction codes may be re-used in different locations when the system is capable of determining the location from which a user is accessing the system. The location in which a user is located may be determined for example, by using information from a cellular network when the user is using a cellular telephone, by using GPS information, etc. Re-use of the transaction codes will allow for shorter codes to be used in identifying transactions. For example, the system may use the same transaction codes for two different products in two different areas, and may identify which product is being ordered based on determining where the user is located.

The above method and system enables quick and easy connection between printed or displayed matter and computer networks.

### BRIEF DESCRIPTION OF THE DRAWINGS

Further features of the invention, its nature and various advantages will be more apparent from the following detailed description, taken in conjunction with the accompanying drawings in which like reference characters refer to like parts throughout, and in which:

FIG. 1 is a flow chart of illustrative steps involved in making transactions available to user in accordance with the present invention;

FIG. 2 is a flow chart of illustrative steps involved in completing a transaction in accordance with the present invention;

FIG. 3 is a flow chart of illustrative steps involved in a transaction from a user's perspective in accordance with the present invention;

FIG. 4 is a flow chart of illustrative steps involved in accepting a transaction from a user in accordance with the present invention;

FIG. 5 is an illustrative block diagram of a telephone transaction handling system in accordance with the present invention;

FIG. 6 is a schematic diagram of a paper magazine advertisement containing two specific-transaction codes in accordance with the present invention;

FIG. 7 is a flow chart of illustrative steps involved in a transaction from a registered user's point of view in accordance with the present invention;

FIG. 8 is a flow chart of illustrative steps involved in multiple transactions from a registered user's point of view in accordance with the present invention;

FIG. 9 is a schematic diagram of an example of a paper bill of payment containing a specific transaction-code in accordance with the present invention;

FIG. 10 is a schematic diagram of an example of a paper invoice containing two specific-transaction codes in accordance with the present invention;

FIG. 11 is a flow chart of illustrative steps involved in a transaction process in accordance with the present invention;

FIG. 12 is a flow chart of illustrative steps involved in assigning an identification code in accordance with the present invention;

FIG. 13 are charts of illustrative structures for a part of database for processing transactions in accordance with the present invention;

FIG. 14 is a diagram of an illustrative transaction handling system in accordance with the present invention;

FIG. 15 is an illustrative functional block diagram of an illustrative transaction handling system in accordance with the present invention;

FIG. 16 is a diagram of an illustrative system having hardware and software for handling transactions in accordance with the present invention; and

FIG. 17 is a diagram of illustrative transactions handling system having different user and vendor terminals in accordance with the present invention.

Skilled artisans will appreciate that some elements in certain FIGS. are illustrated for simplicity and clarity and have not necessarily been drawn to scale.

### DETAILED DESCRIPTION OF THE INVENTION

Vendors and users may interact with a transaction handling system to quickly and efficiently complete transactions. Access to particular transactions may be provided using codes that automate the transaction handling processes. A database of vendor and user information may be used to direct a transaction to an appropriate vendor and to identify users. Acceptance of a transaction code for a particular transaction and a user identification code for a user may be sufficient to place an order. In some embodiments, additional security measures may be used such as using detection techniques to determine whether a user is accessing the system from a telephone number that is known by the system to be related to the user. Other security measures such as user entry of particular information is discussed below. The use of additional security measures may allow the system to assign user identification codes that are short and easy to remember. The transaction code and the identification code may be sent using simple key-entry.

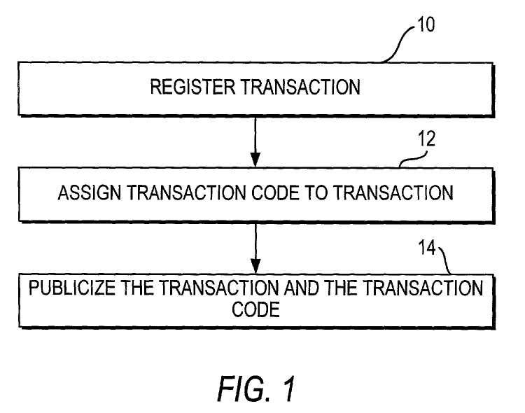

Users may be informed of available transactions by publicizing registered transactions. With reference now to FIG. 1, at step 10, a transaction handling system may register a transaction that is to be made available to users. Registration may involve recording transaction information such as vendor name, product, service, vendor address, accepted forms of payment, etc. At step 12, the system may assign a transaction code to the registered transaction. The transaction code may be a numeric code that is uniquely assigned by the system for that particular transaction. At step 14, the transaction and the transaction code may be publicized to inform users of the availability of that transaction in the transaction handling system.

If desired, the system may publicize the transaction code and the transaction together on a publicly viewable display (e.g., billboards, magazine, newspapers, etc.). The transaction code and the transaction may be displayed in a way that allows users to recognize that the two are related. Additional examples and techniques for registering, assigning a transaction code, and publicizing are illustratively described below.

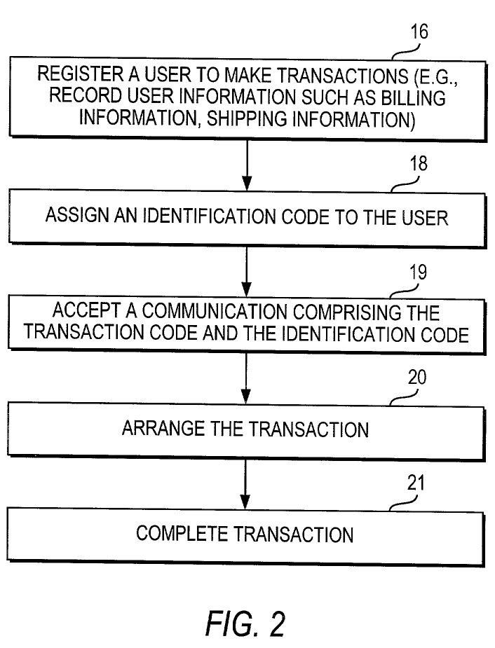

A registered transaction may be completed by a user that is registered to use the system. With reference now to FIG. 2, at step 16, the transaction handling system may register a user who desires to make transactions on the system. Registering a user may involve recording user information such as name, shipping address, billing information, communications addresses, etc. At step 18, the system may assign a user identification code to the registered user. If desired, an identification code may be uniquely assigned to identify the user. In some embodiments, a user may select a code that the system may receive and assign to the user. Initially, the system may assign a user a provisional or temporary identification code that may later be changed with the assistance of the user. The identification code may be a personal identification number or may comprise alphanumeric characters. At step 19, the transaction handling system may accept a communication comprising a transaction code for a particular transaction and an identification code.

At step 20, the transaction handling system may arrange to complete that particular transaction when the transaction code and the user identification code have been accepted. The completion of the transaction may be arranged automatically in response to the acceptance of the transaction code and the user identification code. Arranging the transaction may involve communicating with a vendor, a financial institution, or both to arrange a transaction to be completed. The system may communicate with the vendor or financial institution using any suitable form of communication such as electronic communications, paper communications, voice communications, etc. Communications with vendors may comprise sufficient information to allow the vendor to execute the transaction (e.g., allow the vendor to identify the goods or services, ship the goods, provide the services, etc.). Communications with financial institutions may comprise sufficient information to allow a financial institution to execute the responsibilities of the financial institution in the transaction (e.g., clear the transaction for completion, transfer payment from a user's account to a vendor's account, etc.). If desired, the system may arrange transactions without the system having to communicate with a financial institution. For example, information for executing the responsibilities of a financial institution may be communicated to a vendor and the vendor may forward such information to a financial institution. Information for a financial institution may include information on a user's account (e.g., user's account registered for making payments), user's name, the vendor's account (e.g., vendor's account registered for receiving payments), vendor's name, etc.

At step 21, transactions may be completed. Completing the transaction may involve billing the user, shipping a product to the user, providing a commercial service to the user, etc. If desired, in some embodiments, the system will complete the transaction by for example, billing users, transferring payments, shipping products, providing services, etc. In other embodiments, other entities such as vendors, financial institutions, or both may complete the transaction as discussed above in connection with step 20. Additional examples of and techniques for registering, assigning, accepting, arranging, and completing transactions are illustratively described below.

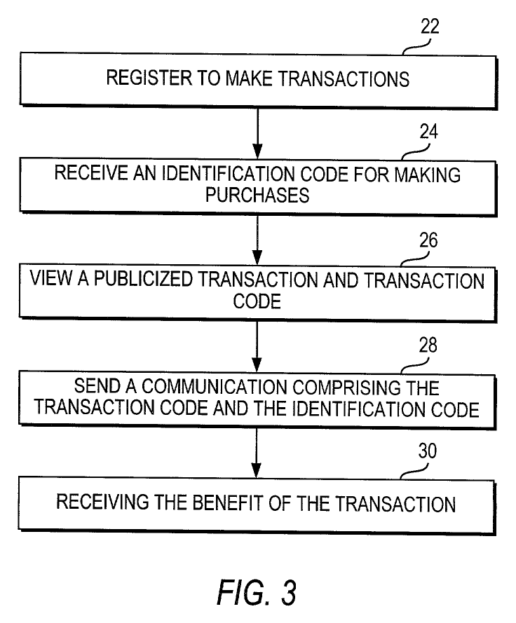

A transaction handling system may operate to interact with individual users in providing transactions to users. With reference now to FIG. 3, at step 22, the transaction handling system may interact with a user to register a user to make transactions on the system. At step 24, a registered user may receive a user identification code from the transaction handling system. At step 26, a publicized transaction and transaction code may be viewed by a user.

At step 28, a user may send a communication to the transaction handling system that comprises the transaction code and the identification code. The communication may be telephonic. The communication may be an aural communication (e.g., spoken voice, DTMF, touch tone, etc.). The communication may be an aural communication that is sent to be received through a public switched telephone network by the system. The communication may be a communication that is from a plurality of communications networks that may use different communications protocols and/or different user terminal platforms. The identification code and the transaction code may be entered by the user to be sent to the transaction handling system using key entry on a telephone or on some other user terminal (e.g., a personal digital assistant, a computer, a pager, etc.). The user terminal may simply include a way of allowing the user to enter the transaction code and the identification code one communication transmission to the transaction handling system (e.g., DTMF signals be used to enter an identification code and a transaction code as one number).

At step 30, the user may receive the benefit of the transaction. For example, a user may receive a product, a service, etc. A transaction may involve providing (e.g., transferring) goods or services between a vendor and a user for a predefined price. A transaction may sometimes involve transferring the payment between the user and the vendor (e.g., transferring payment from the user's registered account on the system to the vendor's register account by a financial institution). Commercial transactions may also have an assigned price of $0.00. Such transactions may be transactions (e.g., providing a catalog may be priced at $0.00) that are in pursuit of a future commercial transaction that involves a price that is greater than $0.00. Additional examples or techniques for interacting with a user are illustratively described below.

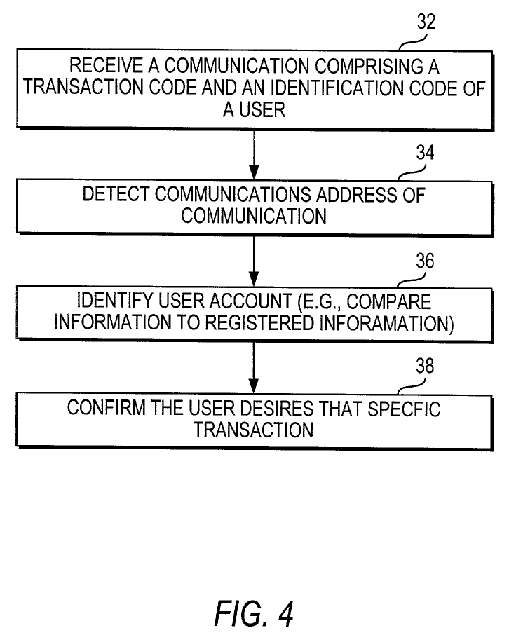

Illustrative steps involved in accepting a communication comprising a transaction code and a user identification code from a user are shown in FIG. 4. At step 32, the transaction handling system may receive a communication comprising a transaction code and a user identification code of a user. The communication may have been received through a public switched telephone network. The communication may be from a wireless communications network (e.g., a wireless communications network that uses protocols such as TDMA, GSM, CDMA, etc.), a landline communications networks (e.g., a public switched telephone network, a private branch exchange), etc. The communication may be a sequence of dual-tone/multi-frequency entries (“DTMF” entries), a public switched telephone network communication,, an analog communication, a digital communication, aural communication, etc. The communication may be received by the transaction handling system on a shared or direct line with the user terminal of the user.

At step 34, the transaction handling system may detect a communications address from which the communication was sent. For example, the transaction handling system may determine the telephone number from which a telephonic communication was sent. Other communications addresses such as a computer network address may also be determined. Techniques for detecting communications addresses are known to those skilled in the art (e.g., caller identification techniques such as Caller ID and ANI).

At step 36, the transaction handling system may identify a user account. The system may compare the sending communications address to a database containing information on the communications addresses of registered users. The communications addresses may have been recorded in the database when the user registered with the system. The transaction handling system may determine whether the user identification code matches the registered account having the sending communications address. If desired, step 34 may be omitted and the user account may be identified based on the user identification code that is in the communication. Other criteria such as those that are discussed herein may also be used to identify a user account.

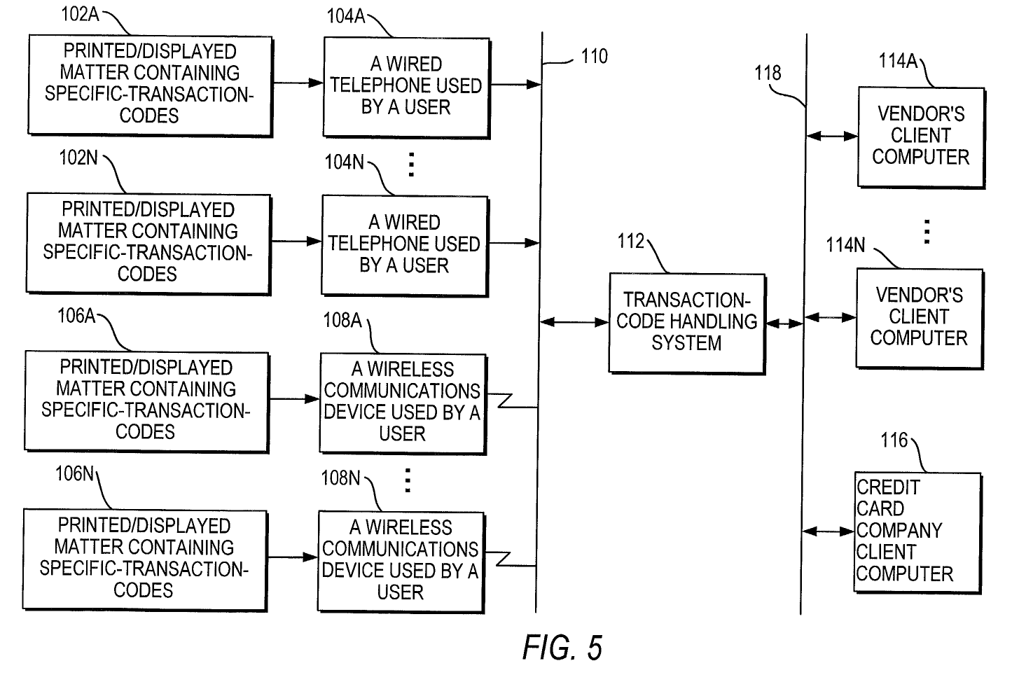

At step 38, the transaction handling system may confirm that the user desires to complete the transaction. The user may be prompted to confirm the transaction. For example, in telephonic communications, the transaction handling system may prompt the user to confirm the transaction and if desired, provide the specifics of the transaction to the user. As described in connection with FIG. 5, the system may be a system that has sufficient hardware and/or software to automatically accept a communication (e.g., the system may have automated to receive a communication comprising a personal identification code and transaction code). Additional examples of or techniques for receiving a communication, detecting a communication, identifying a user account, and confirming the transaction are illustratively described below.

FIG. 5 illustrates a block diagram of one telephonic embodiment of the present invention method and system. Users 104A-104N and 108A-108N may be users who are reading printed matter 102A-102N and 106A-106N. The printed matter may contain specific-transaction codes. Users 104A-104N may use landline telephone terminals. These telephone terminals can be of any commercially available tone-dial type (e.g., DTMF telephones), with or without alphanumeric displays and with or without scanning devices. Users 108A-108N may use wireless communications terminals of any commercial type with an interface to the public telephone network, with or without alphanumeric displays and with or without scanning devices. The wireless communications devices can be devices such as cellular telephones of any commercially available type or wireless PDA (Personal Digital Assistants). Each one of users 104A-104N may have a user terminal that is in a different communications network and may each operate based on different communications protocols (e.g., landline communications protocols, wireless communications protocols, etc.).

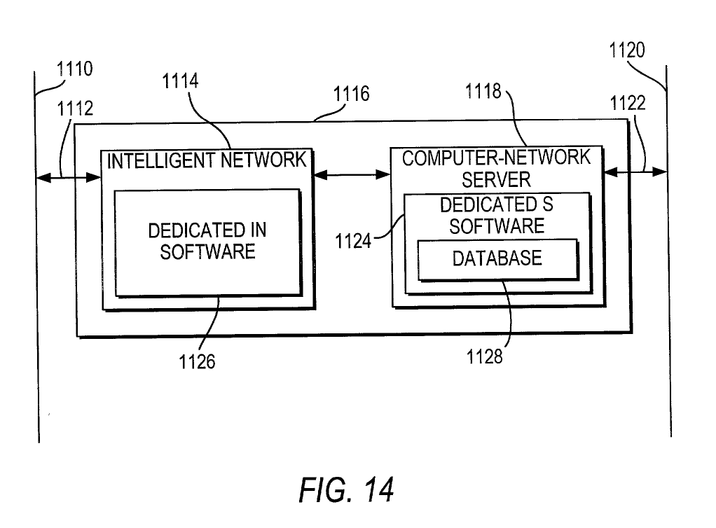

One or more transaction-code handling systems 112 may be connected to the telephone network 110. If desired, telephone network 110 may be a public switched telephone network through which systems 112 receive a communication for ordering transactions from users or may be some other type of communications network. In one embodiment, systems 112 may contain an intelligent network, a computer network server computer, and dedicated software. Examples of hardware, software, and end functional system blocks of systems 112 are illustratively described in connection with FIGS. 14-16. Transaction-code handling systems 112 may also be connected to vendor client-computers 114A-114N via communication link 118. Communication link 118 refers to any type of wire or wireless link between computers such as communication links in LANs, WANs or a combination of computer networks. For example, communications link 118 can be a network such as the Internet.

A vendor client computer 114 can be any type of computing device (e.g., a personal computer, server, dedicated application computer, etc.) with an interface to communications link 118.

One or more credit card companies and/or other financial institutions such as banks may have client computers 116 that may also be connected to communications link 118 for possible data exchange with transaction-code ordering systems 112.

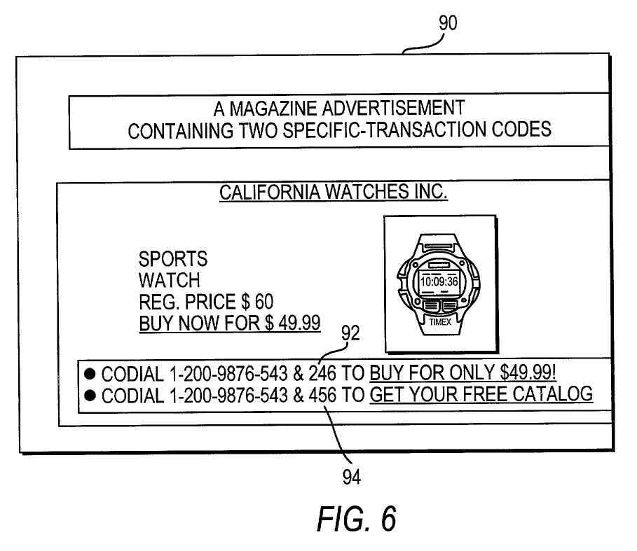

With reference now to FIG. 6, paper magazine advertisement 90 contains two specific-transaction codes 92 and 94. At the bottom of advertisement 90 the following note is printed:

“CODIAL 1-200-9876543 & 246 TO BUY NOW FOR ONLY $49.99”

In the above example the term “Codial” indicates to the users that the following numbers, when dialed, will be used to generate a transaction order. The 1-200-9876-543 is the access number a user has to dial to enter a transaction code or to enter an address in the system for the product vendor (California Watches Inc.). Transaction code 92 that includes the number “246” may correspond to a specific transaction order for buying the advertised watch for $49.99. Users may be aware of this advertising format and may know that the specific-transaction code will follow the “&” sign after the access number.

The format for the access number and specific-transaction codes including (e.g., the number of digits) can vary and may not necessarily be identical to the ones shown herein. For example the code may include digits to specify the number of identical items to be ordered. The access number may include digits, letters, or combinations thereof to enable long-distance and/or international transactions. The format for presenting the access number and specific-transaction code can be of various forms and may not necessarily be limited to the ones shown herein. However, typically, each specific-transaction may be represented by a combination of an access number and a specific-transaction code and is sufficiently defined in the printed or displayed matter to have one code combination represent one defined transaction. Since the transaction is defined by the access number and specific-transaction code, the user does not need to ask questions or to go through tedious menus. Moreover, the automatic identification of users such as those described herein generates transactions that are very efficient and comfortable for users.

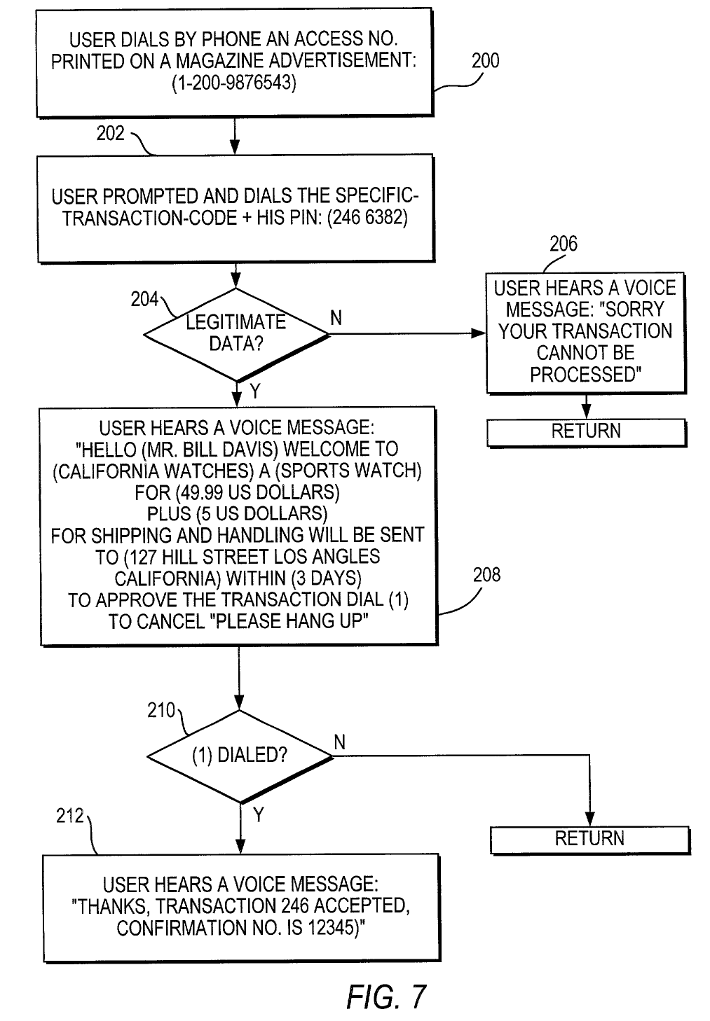

FIG. 7 is a flow chart illustration of an illustrative transaction process from a registered user's point of view in a telephonic embodiment of the present invention. The transaction process begins in this illustration with a user who reads an advertisement printed in a magazine (such as for example, FIG. 6). The user may have previously been instructed on how to use the transaction handling system. At step 200, the user may have previously entered into an agreement to become a user of the system. The user may want to buy the advertised item (e.g., a watch) and may use his telephone to dial the access number printed on the advertisement. At step 202, the user is then entered into the transaction code handling system, which prompts him to enter (e.g., using aural communication) the specific-transaction code and his PIN (246-6382 in the example).

Some public telephone switching networks allow longer numbers to be dialed so that the access number and the specific-transaction code and PIN could be dialed all at once (e.g., by dialing 1-200-9876543-246-6382 from the above example all at once). If desired as described herein, a registered user may communicate an identification code, a transaction code, or both using a voice communications.

Specific pre-registered telephone numbers (communications addresses) may be specified by the user at registration for use in transactions on the system. The telephone numbers may be telephone numbers that a user may place telephone calls from, such as, the user's cellular telephone number, home telephone number, office telephone number, etc. These numbers are stored in the transaction code handling system database and may be used in conjunction with the PIN to identify the calling user. If desired, the PIN or user identification code may be uniquely assigned to allow for user identification without additional information.

If desired, transactions may also be ordered from telephone numbers that are not pre-registered. In this case the user will have to identify himself by dialing additional identification numbers besides the PIN (for example, his Social Security number or his home telephone number may be entered).

At step 204, the system may determine whether legitimate data has been entered by the user. If the dialed specific-transaction code and PIN are identified by the system, the system may determine that the entered data is legitimate. The system may identify the registered user and match the dialed symbols for the transaction code with the transaction information in the system's database. At step 208, the user may hear a voice message informing him of his personal information (e.g., name, mailing address, etc.) that were identified by the system and a description of the transaction details as understood by the system (in the above example, buying a watch for $49.99). The system can also compute shipping and handling fees based on the user's address, the vendor's address, and other predefined parameters. In step 208, a voice message is played that asks the user to approve or cancel the described transaction by dialing a specified number. If the user notes that his data and the desired transaction data were correctly recognized by the system, he can approve the transaction (step 210). At step 212, the system may then confirm that the desired transaction was accepted and may give the user a confirmation number (e.g., a reference number) for that transaction. In some embodiments, the system will not generate the transaction if at step 210 the user hangs up or disconnects from the system.

At step 206, the system may tell the user that the transaction could not be processed and may clear the call when the system determines at step 204 that the data entered by the user is not legitimate.

The above described illustrative transaction deals with buying a product. The methods and systems illustratively described herein can also be used for many other transaction types between users and vendors that involve printed or displayed matter that is used in connection with a computer network. Transaction types such as services for transferring information or paying a bill may be provided as described below. The system may describe by voice message the transaction details to the user so that the user can be informed of the exact transaction that is about to be performed. The system may also let the user know that he was correctly identified.

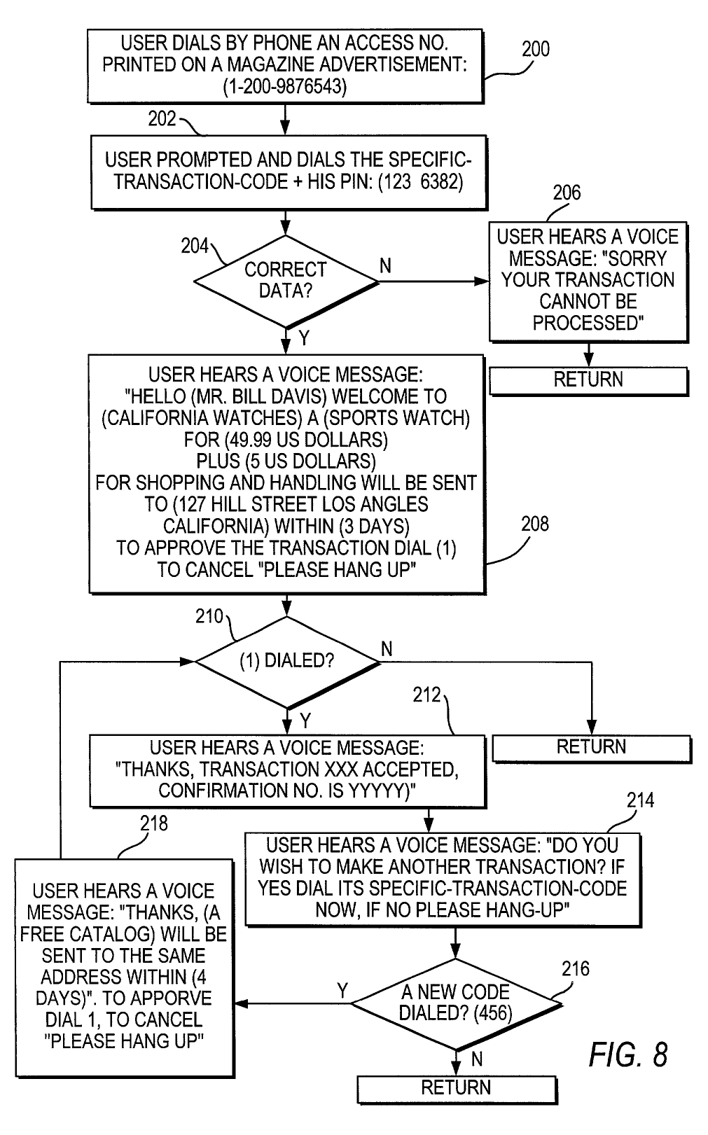

FIG. 8 is a flow chart illustration of an illustrative transaction process that includes continuing transactions. In this embodiment, the system may accept additional transactions after a first transaction. At step 214, the system may ask the user whether the user would like to make an additional transaction and may inform the user that additional transaction codes may be entered at this time. If desired, at step 216, the system may accept the transaction without requiring re-entry of the PIN or without requiring the dialing of an access number.

The user then hears a voice message telling the user the description of the additional transaction as understood by the system. The transaction name “XXX” and confirmation number “YYYYY” of step 212 may change for each specific-transaction. When the user stops dialing additional specific-transaction codes the process may be terminated by the system.

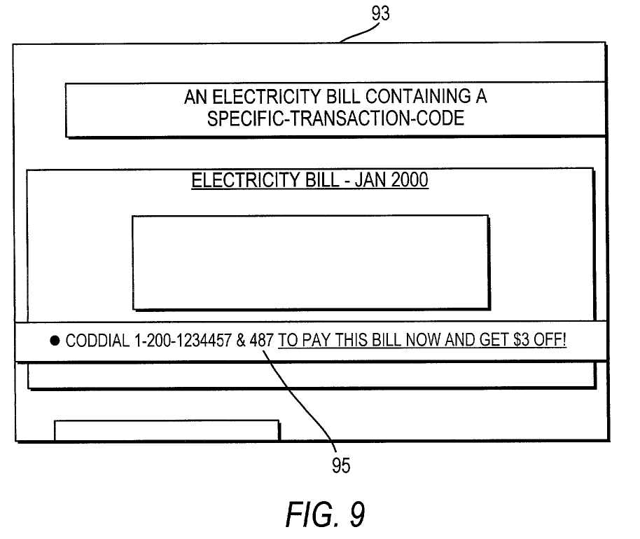

FIG. 9 is a schematic example of paper bill 93 containing specific-transaction code 95. This figure illustrates an example of another application of the present invention. In this example a user receives printed electricity bill 93. The electric company may be a registered vendor in the transaction handling system. The vendor may have printed specific-transaction code 95 as “487” along with an access number on bill 93 to enable a registered user to efficiently pay the bill by dialing specific-transaction code 95 using his telephone. The transaction may be handled by the transaction-code handling system to pay the bill for the user. In the bill payment process of the system, the specific data of the user's bill is retrieved from the system's database and a voice message is generated that reads to the user the bill's data (e.g., bill issuer, dollar amount, date, etc.). The user may be asked to confirm the payment and may receive a confirmation number. Typically, a vendor may be required to execute an agreement to be registered on the system.

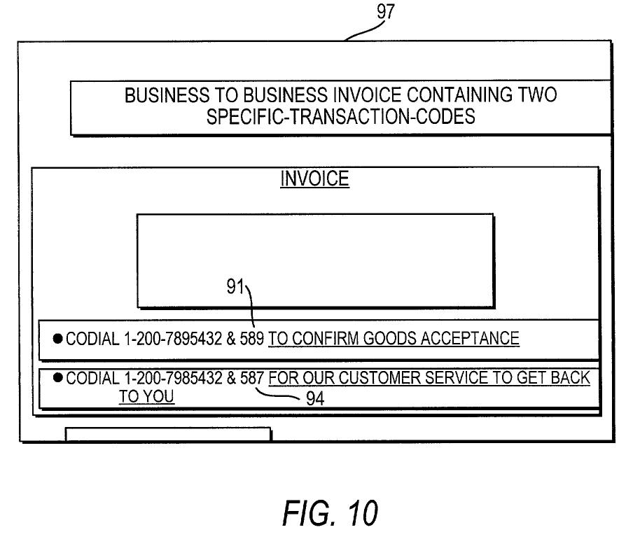

Paper invoice 97 schematically shown in FIG. 10 includes two specific-transaction codes 91 and 94. FIG. 10 illustrates another example of an application of transaction handling systems and methods in business to business environments. In this example, a sending business (the vendor in this example) prints two specific-transaction codes 91 and 94 on invoice 97 that is sent with goods to a receiving business. The receiving business employee (the user in this example) uses his telephone to dial the appropriate specific-transaction code in order to report the status of the received goods to the computer network of his business and to the computer network of the sending business. The transaction may be handled by the transaction code handling system in a similar way as that described above in connection with FIGS. 1-4 and 5-8, but in this example the transaction involves an information exchange and not a goods and/or monetary exchange.

The above process can also be used to execute transactions between individuals who are connected to a computer network and registered to the system. For example a family (who may be the vendor in this case) can post a message in a bulletin board with a specific-transaction code for selling their house. A user who calls the posted access number and dials that specific-transaction code may receive (by e-mail in this example) more data on the specific house for sale.

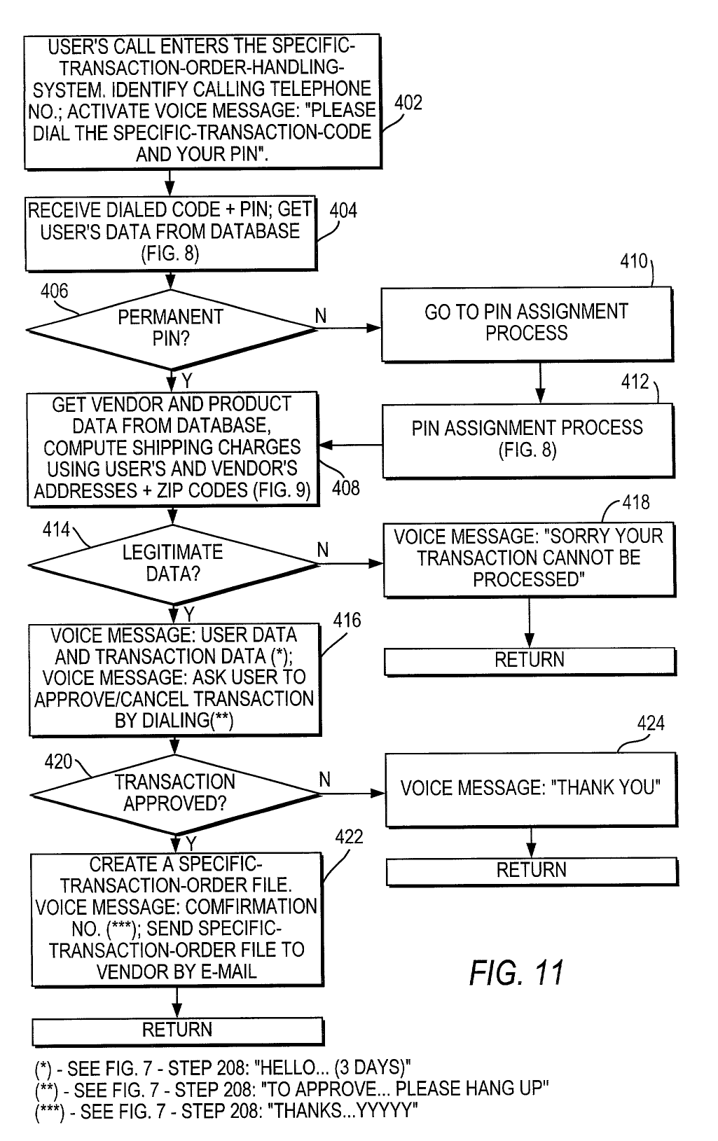

An illustrative flow chart for telephonically completing transactions automatically is shown in FIG. 11. The process may begin with a user's call for entering a communications network of the system when a user dials an access number at step 402. The communication network may be an intelligent network that is further discussed below. The system's network may have a number of access numbers that may have been selected as a function of the number of vendors and users that the system is planned to handle.

The network may be capable of handling communications utilities such as identifying the calling telephone number or communication address and may provide that number into the system's computer software (further discussed below). Identification of a calling telephone number or communications address is usually available in communications networks in which the user has not selected to block identification. In some embodiments, the telephone operator systems will enable selective-programmable identification blocking. In these systems, a user can ask a telephone or communications provider to have the blocking removed when he calls the system's access numbers and the blocking to be active when he calls other numbers.

When the system is accessed, the system may activate a voice message telling the user to “Please dial the specific-transaction code and your PIN.” The user, who may have been previously instructed (by mail, email, advertisement, etc.) on how to use the system will know to recognize the specific-transaction code in the printed or displayed matter that he is reading or watching and to continuously dial his PIN. Step 402 might be divided for user convenience into two steps one for entering the PIN and one for entering the transaction code.

In one embodiment, there may be two types of PINs (Personal Identification Numbers) in the system. The first one may be a provisional PIN. This PIN could be a 4-digit number (in other embodiments it may have a different number of digits or letters). The user may receive the provisional PIN personally or by mail or e-mail prior to the user using the system. This provisional PIN can be for example the number 6382 for a certain user. In some embodiments, for security reasons and for increased ease of use, the provisional PIN will enable the user to enter the system for the first time and be identified but it will not enable him to generate transaction orders.

The second type of PIN may be a permanent PIN. The permanent PIN could be assigned by the system when a user selects a particular number for the PIN. The user may select a particular number when the user enters the system for the first time. The system may assign the selected number to be the PIN for that user. The permanent PIN enables the user to execute transaction orders using the system.

Following step 402, the system (e.g., the software of the system) may receive the specific-transaction code and may retrieve the calling user's data from the database at step 404. The user data may include several fields.

The user data may include assigned telephone numbers of the user (for example 1-217-1234-567). One or several telephone numbers or communications addresses of the user could have been selected at registration for enabling the execution of transactions by the system. These numbers can be for example the user's cellular telephone number, his home telephone number, and his office telephone number. These numbers are used for security reasons so that in conjunction with a short PIN the calling user can be identified and traceable. In other embodiments, the system may enable the user to execute transaction orders from any telephone number, but in these situations, the system would be less user-friendly, because for security reasons, the user will have to dial a pre-assigned identification number (e.g., the user's Social Security, home telephone number, etc.) in addition to his PIN for a safe identification.

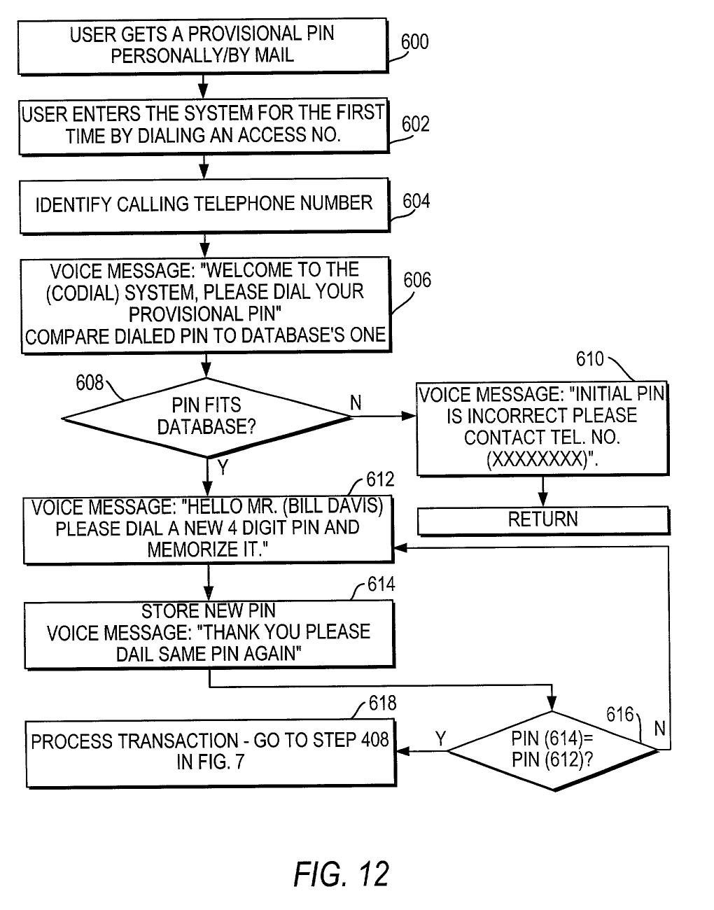

In step 406, the system may check a database of registration information to determine whether the user dialed his permanent PIN. If the user has entered a provisional PIN, the process may continue to steps 410-412 involving the permanent PIN assignment process (described in FIG. 12).

If the permanent PIN for that user has been entered, the system may retrieve the vendor data and product data (e.g., data on goods or services) from the database and may compute shipping and handling fees at step 408. The fees may be based on the user's address, the vendor's address, and possibly on additional parameters. In step 414, the system may check whether the specific-transaction code entered by the user was legitimate (e.g., by matching the code to the database). If the code is legitimate, the system may generate a voice message (see FIG. 7 step 208) and ask the user to confirm the transaction at step 416. If the code is not legitimate, the system may generate a voice message telling the user that the transaction couldn't be processed and may clear the call at step 418.

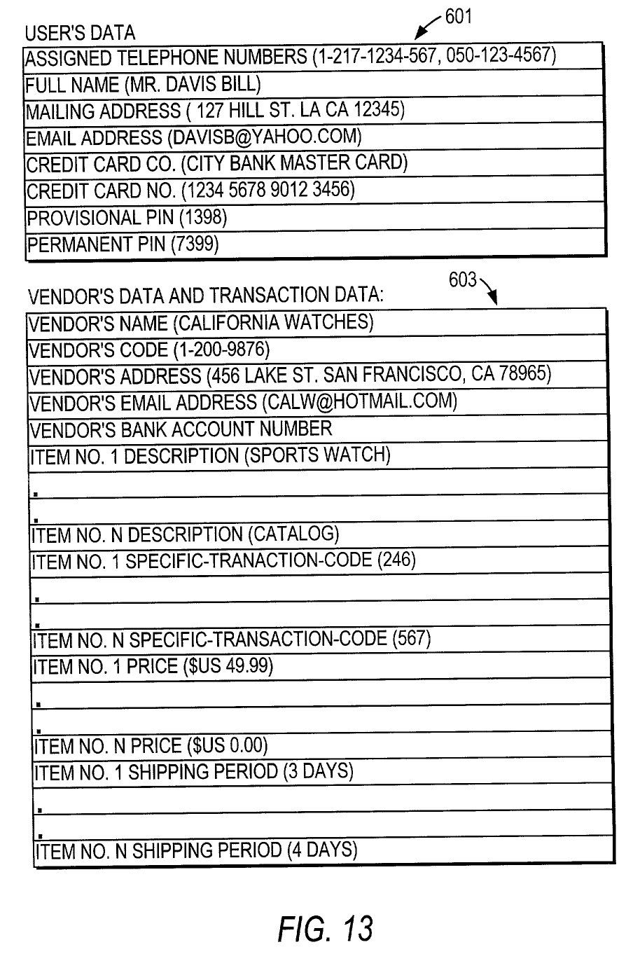

At step 420, the system may check whether the user approved the transaction. If the transaction is not approved, the system may generate a “thank you” message at step 424 and may clear the call. If the transaction was approved, the system may create a specific transaction order file, which may contain all the needed transaction data (see FIG. 13), and may send the file to the vendor by e-mail via the Internet at step 422. The document may be sent to the vendor in other ways such as using regular mail, a dedicated communications connection, etc.

FIG. 12 is an illustrative flow chart showing an illustrative PIN assignment process. The user may be provided with a provisional PIN personally (or by secure mail) on registration with the system at step 600. The provisional PIN may enable the user to enter the system by dialing an access number (step 602), but may not enable the user to make transactions. The system may identify the calling telephone number at step 604 and ask the user using for example, a voice message to enter the provisional PIN (step 606), and may compare the PIN to the PIN stored in the database (step 608).

If the PINs do not match the system may notify the user to contact a customer service telephone number and may clear the call at step 610. If the PINs match, the system may ask the identified user to select and enter a new PIN, which will be the user's permanent PIN, at step 612. For verification the system may ask the user to again enter his PIN at step 614 until the two inputs match (step 616). After a match, the user can continue to make transactions using the system (step 408 FIG. 11).

FIG. 13 illustrates a part of the system's database. The database may contain, among other things, the essential data needed for the execution of a specific transaction. The data may be the user's data that was recorded at the user's registration (e.g., assigned telephone numbers, name, mailing address for goods and documents, assigned credit card type, credit card number, expiration date, and a provisional PIN, etc.). The permanent PIN can be entered into the database on the first use of the system by the user.

The database may also contain vendor's data 603 (e.g., name, address, assigned bank account, etc.). The transaction data may contain all the transaction descriptions enabled to be executed with this vendor, the assigned transaction codes for the transactions, and prices. In the case of a transaction which does not involve a monetary transfer, the price will be $0.00.

FIG. 14 illustrates a block diagram of the components of one embodiment of the transaction handling system. System 1116 may contain two major subsystems comprising intelligent network 1114 and computer-network server computer 1118 (which may be an Internet server). Intelligent network 1114 which may contain dedicated software 1126 may handle the telephone network functions and utilities of the system (switching, voice messages generation, calling number identification, etc.). Intelligent network 1114 may be connected to telephone network 1110 via telephone network link 1112. Intelligent network 1114 may be connected via a data communications link to server 1118. Server 1118 may generate the transaction-orders and may send them via computer network 1120 to the vendors (and in some embodiments also to other computers, for example to the financial institution's computer). Server 1118 may contain a dedicated server software 1124 and database 1128 for the user's data, vendors data and financial institutions data.

The server 1118 may be connected to the network 1120 (e.g., the Internet) via a computer network link 1122. Telephone network 1110 may be a public switched telephone network or some other communications network. Intelligent network 1114 may handle communications network functions and utilities of the system

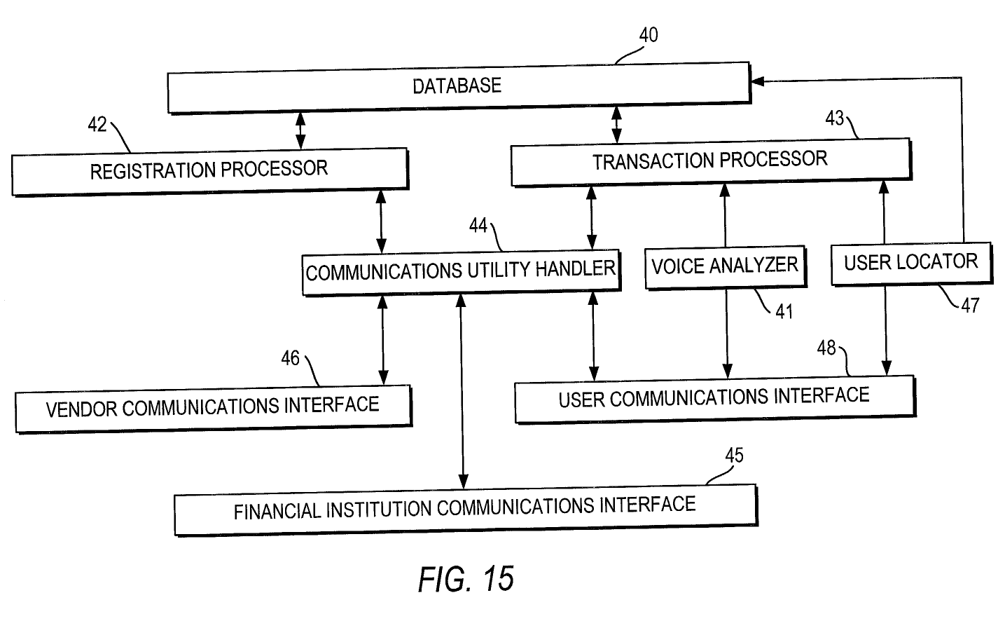

With reference now to FIG. 15, the transaction handling system (e.g., system 1116 of FIG. 14) may comprise a plurality of functional blocks that may each comprise hardware, software, or a combination thereof. The transaction handling system may comprise database 40, registration processor 42, transaction processor 43, communications utility handler 44, financial institution communications interface 45, voice analyzer 41, user locator 47, vendor communications interface 46, and user communications interface 48. Database 40 may store information (e.g., see FIG. 13) that is recorded when registering vendors and users. Database 40 may also contain other information such as the user identification codes for each user account and the transaction codes for available transactions. Database 40 may be accessed to retrieve desired information.

Vendor communication interface 46 may be a communications interface that handles communications with vendors. Vendor communications interface 46 may receive and transmit communications between the transaction handling system and the vendors. For example, vendor communications interface 46 may send a specific transaction order to a vendor in response to transaction processor 43 accepting a transaction code. Vendor communications interface 46 may be for providing communications via telephony, via a computer network, via e-mails, etc.

User communications interface 48 may be a communications interface that handles communications with users. User communications interface 48 may receive or transmit communications between the transaction handling system and users. User communications interface 48 may be for providing communications via telephone, via a computer network, via e-mails, etc. User communications interface 48 may be part of intelligent network 1114 of FIG. 14.

Financial institution communications interface 45 may be a communications interface that handles communications with financial institutions. Financial institution communications interface 45 may receive and transmit communications between the transaction handling system and the financial institutions. For example, financial institution communications interface 45 may send a specific communication (e.g., a payment transfer request) to a financial institution in response to transaction processor 43 accepting a transaction code.

Financial institution communications interface 45 may be for providing communications via telephony, via a computer network, via e-mails, etc.

Communications utility handler 44 may be a utility that handles communications tasks that are beyond the capabilities of user communications interface 48 or vendor communications interface 46. For example, communications utility handler 44 may detect the communications address that is sending a communication (e.g., user Caller ID to detect a telephone number). Other examples may involve handling a plurality of simultaneous communications, switching communications, etc.

If desired, vendor communications interface 46, user communications interface 48, and financial institution communications interface 45 may communicate with registration processor 42 and transaction processor 43 without the use of communications utility handler 44.

Registration processor 42 may communicate with database 40, with communications utility handler 44, with vendor communications interface 46, and with user communications address 48. In operation, registration processor 43 may make transactions available to users on the system. Registration processor 43 may register vendors, transactions, and users, which may involve obtaining information on transactions, vendors, or users (e.g., user billing and shipping information) and recording the information to database 40. Registration processor 42 may assign a transaction code to every transaction that is registered and may assign a user identification code to every user that is registered. If desired, registration processor 42 may record information about a user's voice during registration to allow the identification of the user based at least partly on his voice (e.g. records a voice signature comprising an identification code). Also if desired, information on a word that is spoken by the user (e.g., a word selected by the user) may be recorded to allow for the identification of the user based on the word (e.g., identify the word that is spoken), based on the user's voice, or a combination thereof.

Transaction processor 43 may communicate with database 40, with financial institution communications interface 45, with voice analyzer 41, with user locator 47, with communications utility handler 44, with vendor communications interface 46, and with user communications interface 48. In operation, transaction processor 43 may handle activity for completing transactions between a user and a vendor. Transaction processor 43 may perform steps illustratively described above for arranging to complete transactions such as accepting a communication comprising a transaction code and a unique identification number, arranging that the transaction be completed for the user, comparing a communications address to information in database 40, comparing a user identification number to identification numbers in database 40, billing users for transactions, having products shipped to users based on shipping information in database 40, etc. If desired, transaction processor 43 may accept a communication consisting only of a personal identification code and a transaction code and in response transaction processor 43 may arrange the transaction.

If desired, the system may include user locator 47. User locator 47 may communicate with user communications interface 48, transaction processor 43, and database 40. User locator 47 may determine the location of a user who is accessing the system. User location may be determined in a variety of ways. For example, user location may be determined from a wireless telephone network from which a user may be accessing the system, from a GPS system, etc. User locator 47 may provide information about the location of the user to transaction processor 43. In implementations where one transaction code is used for more than transaction in different areas (e.g., transaction code “2339” is user in Albany, N.Y. to buy a watch and is used in Los Angeles to buy a radio), transaction processor 43 may use the location information from user locator 47 to determine which one of the transaction a user desires. User locator 40 may access information in database 40 in locating users.

If desired, the system may include voice analyzer 41. Voice analyzer 41 may communicate with user communications interface 48, transaction processor 43, and database 40. Voice analyzer 41 may receive voice communications of a user who is accessing the system from user communications interface 48. Voice analyzer 48 may access database 40 to obtain information about the voices of registered users and/or the identification codes of users. Voice analyzer 41 may identify a calling user's voice based on information in database 40. If desired, voice analyzer 41, or transaction processor 43 in cooperation with voice analyzer 41 may identify a registered user that is accessing the system based on the user's voice, a word that a user has selected to be used as a user identification code at registration, the caller ID of the calling party, any other suitable resource, or using any suitable combination thereof. For example, voice analyzer 41 may recognize an identification code using voice recognition techniques to match the spoken identification code with the user's assigned identification code in identifying the user. Voice analyzer 41 may be provided with information for use in identifying users from transaction processor 43, database 40, user communications interface 48, etc.

If desired, voice analyzer 41 may compare a voice communication from a user that comprises a spoken user identification code with voice signatures that may have been recorded during registrations of users. A user may be identified based on the comparison.

It is to be understood, that the configuration and connections of FIG. 15 are illustrative and that variations in the configurations and connections may be made.

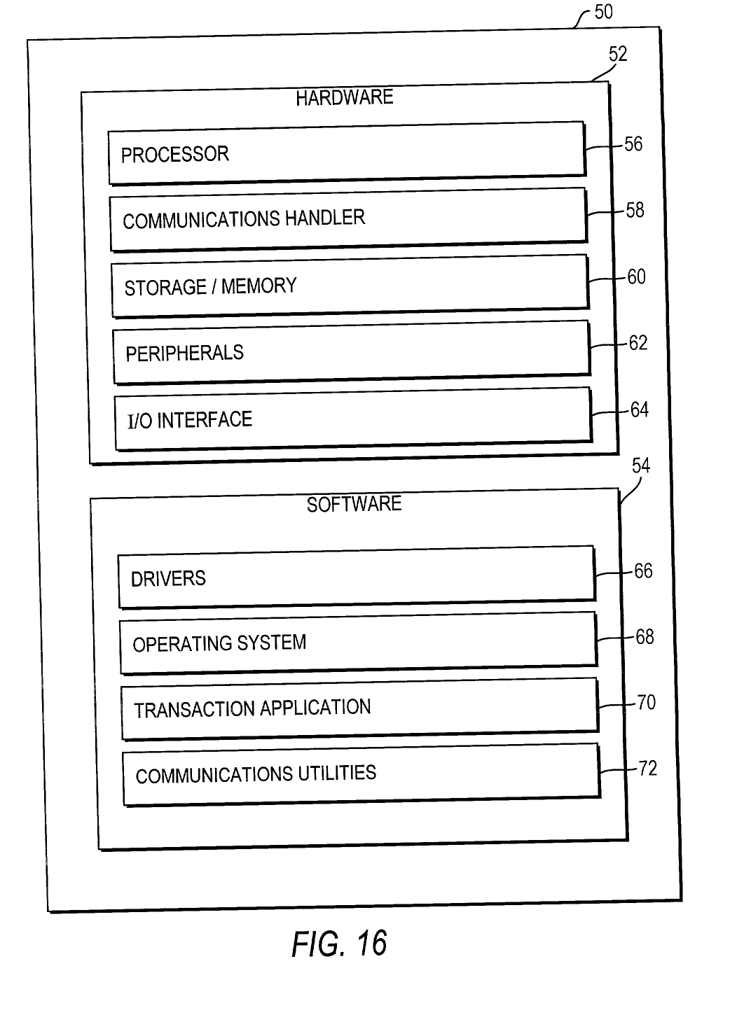

A platform for the functional blocks of FIG. 15 is illustratively shown in FIG. 16. Platform 50 may be a computer, a personal computer, a server, a workstation, two or more network computers (e.g., the system shown in FIG. 14), dedicated telecommunications equipment, etc. Platform 50 may comprise hardware 52 and software 54. Hardware 52 may comprise processor 56 that processes logical operations, communications handler 58 that is a communications interface (e.g., a modem, an ethernet connection interface, interfaces for a plurality of wireless or landline communications, etc.), storage 62 that is temporary storage, long-term storage, or both (e.g., RAM, ROM, a hard drive, floppy drive, optical disc, tape, etc.), peripherals 62 (e.g., printers, scanners, etc.), input/output interface 14 such as, a keyboard, mouse, monitor, scanner, etc.).

Software 54 may comprise drivers 66 for driving components of hardware 52 (e.g., driving communications handler 58, peripherals 62, interface 64), operating system 68, transaction handling application 70 for implementing some or all of the methods discussed herein, communications utilities 72 for performing communications utilities such as detecting a source of a communication. Communications utilities 72 may comprise features for providing secure connections (e.g., for providing firewalls). In operation, platform 50 may operate using hardware 52 and software 54 to provide registration processor 42, transaction processor 43, communications utility handler 44, vendor communications interface 46, user communications interface 48, database 40, etc.

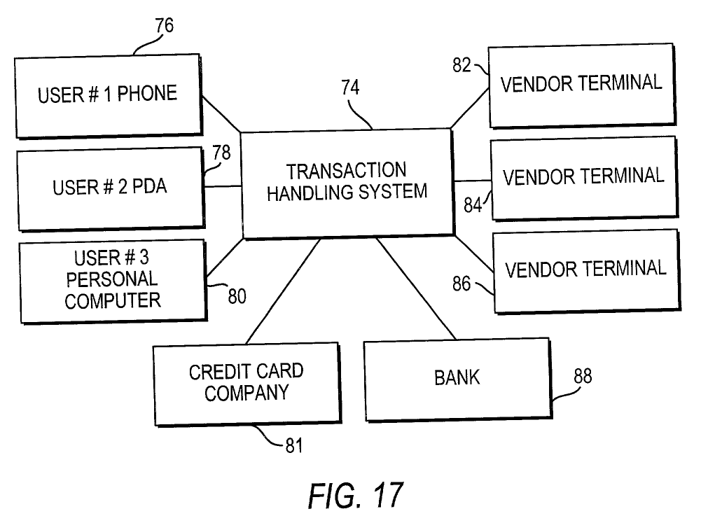

With reference now to FIG. 17, transaction handling system 74 may have sufficient hardware and software to communicate and handle transaction orders from a plurality of different user terminal platforms. For example, transactions handling system 74 may receive a communication (e.g., an aural communication) comprising a transaction code and a user identification code from a telephone platform (e.g., telephone 76), a PDA platform (e.g., PDA 78), and a personal computer platform (personal computer 80). Each one of user terminals 76, 78 and 80 may send an appropriate communication to have transaction handling system 74 arrange for a transaction to be completed with a vendor. Transaction handling system 74 may also communicate with a plurality of vendor terminals 82, 84, and 86 that may each be for a different vendor and may comprise different types of communications terminals (e.g. different types of terminal platforms). Transaction handling system 74 may have a communications connection with financial institution 88 for handling payments between vendors and users. Financial institution 78 (e.g., a bank, credit card company, debit card company, etc.) may be assigned by a registered user to transfer payments for transactions from the user's account to the account of the vendor. Information about the financial institution 78 may have been recorded when users registered to use transaction handling system 74. System 74 may communication with a plurality of financial institutions, credit card company 81, bank 88, that may each have different types of terminals for communicating with system 74. A scanning device may be used for entry of a personal identification code and/or transaction code in user terminals such as telephone 76, PDA 78, and personal computer 80. The scanning device may allow entry of such communication information for transmission to the system.

Each user terminal may be in a different communications network that may each use a different communications protocol for communicating with user terminals in that communications network. For example, PDA 78 may communicate with a communications network of a communications provider using a TDMA communications protocol and telephone 76 may be a wireless telephone that may communicate with a communications network of a communications provider using a CDMA communications protocol. An advantage of this is that the system is compatible with a number of different communications networks, compatible with communications that are from networks using different protocols, etc. This flexibility allows the system to operate without being dependent on what type of user terminal, user terminal platform, originating communications protocol, etc. is used.

If desired, in situations where a user may desire to select a payment amount that will be transferred in a transaction (e.g., when the user is paying a credit card bill), the system may give the user a chance to enter a dollar amount for the transaction. For example, the user may enter a dollar amount after entering a personal identification code.

In some embodiments, a personal identification code and a transaction code are provided to or received by the system using aural communications. Any form of aural communications technique may be used to provide such communications (e.g., telephone, voice over IP, etc.).

Thus, a system is provided that overcomes the deficiencies in known transaction handling systems and quickly completes transactions for users. Moreover, the system may handle many simultaneous transactions at a cost that is much lower than known techniques such as human-operated call centers.

The foregoing is merely illustrative of the principles of this invention and various modifications can be made by those skilled in the art without departing from the scope and spirit of the invention.

What is claimed is

1. A transaction method comprising:
registering at least one available transaction;
assigning to said at least one available transaction a transaction code to be publicized;
registering at least one user, said registering including recording payment information from each said at least one user;
assigning a personal identification code to each said at least one user;
accepting automatically an aural communication including said personal identification code and said transaction code; and
arranging said at least one available transaction to be completed for said at least one user, including arranging to have payment collected based on said recorded payment information.

2. The method of claim 1 wherein said accepting comprises accepting automatically an aural communication from any one of at least two communications networks that each provide communications based on a different communications protocol.

3. The method of claim 2 wherein said telephonic aural communication occurs over a landline telephone.

4. The method of claim 2 wherein said telephonic aural communication occurs over a wireless telephone.

5. The method of claim 2 wherein said registering at least one user includes recording at least one telephone number of said at least one user, said method further comprising detecting a telephone number from which said telephonic aural communication originates, and said accepting includes verifying that said telephonic aural communication originates from one of said at least one recorded telephone numbers of said at least one user.

6. The method of claim 2 wherein said registering at least one user includes recording at least one communications address of said at least one user, said method further comprising detecting a communications address from which said telephonic aural communication originates, and said accepting includes verifying that said telephonic aural communication originates from one of said at least one recorded communications addresses of said at least one user.

7. The method of claim 2 wherein said registering at least one user comprises recording shipping information from each said at least one user, and said arranging comprises arranging for a shipment to be made based on said recorded shipping information.

8. The method of claim 2 further comprising confirming that said at least one user desires said at least one available transaction.

9. The method of claim 2 further comprising accepting said telephonic aural communication as one number that is entered by said at least one user to include said personal identification code and said transaction code.

10. The method of claim 2 wherein said arranging comprises arranging said at least one available transaction automatically in response to said accepting.

11. The method of claim 2 wherein said aural communication is a voice communication.

12. The method of claim 2 further comprising recognizing said personal identification code when said personal identification code is spoken in said aural voice communication, and wherein said accepting comprises accepting automatically said aural voice communication based on said recognizing.

13. The method of claim 2 wherein said registering at least one user comprises recording a signature of said at least one user speaking said personal identification code, said method further comprising comparing said signature with said personal identification code spoken in said aural voice communication, and said accepting comprising accepting automatically said aural voice communication based on said comparing.

14. The method of claim 2 wherein said at least one user is one of a plurality of registered users that each have a different user terminal platform and wherein said accepting comprises accepting aural communications from each of said different user terminal platforms.

15. The method of claim 2 wherein one of said two communications networks is a wireless communications network and the other one of said two communications networks is a public switched telephone network.

16. The method of claim 2 wherein said aural communication comprises dual-tone/multi-frequency entries.

17. The method of claim 2 further comprising registering one transaction that is available from said at least one user when said at least one user is registered.

18. The method of claim 2 further comprising registering at least one vendor of said at least one available transaction, said registering including recording payment information from each of said at least one vendor.

19. The method of claim 18 wherein said accepting comprises permitting said at least one registered vendor to request one of said at least one available transactions to be completed when said at least one vendor is registered.

20. The method of claim 2 wherein said registering at least one transaction comprises registering two transactions for two different locations, said assigning a transaction code comprises assigning to each of said two transactions said transaction code, said accepting comprising determining a location of said at least one user, and said method further comprising locating from where said communication is sent to identify one of said two transactions.

21. The method of claim 2 wherein said personal identification code is a unique identification code.

22. The method of claim 1 wherein said aural communication is telephonic.

23. The method of claim 22 wherein said telephonic aural communication occurs over a landline telephone.

24. The method of claim 22 wherein said telephonic aural communication occurs over a wireless telephone.

25. The method of claim 22 wherein said registering at least one user includes recording at least one telephone number of said at least one user, said method further comprising detecting a telephone number from which said telephonic aural communication originates, and said accepting includes verifying that said telephonic aural communication originates from one of said at least one recorded telephone numbers of said at least one user.

26. The method of claim 22 wherein said registering at least one user includes recording at least one communications address of said at least one user, said method further comprising detecting a communications address from which said telephonic aural communication originates, and said accepting includes verifying that said telephonic aural communication originates from one of said at least one recorded communications addresses of said at least one user.

27. The method of claim 22 wherein said registering at least one user comprises recording shipping information from each said at least one user, and said arranging comprises arranging for a shipment to be made based on said recorded shipping information.

28. The method of claim 22 further comprising confirming that said at least one user desires said at least one available transaction.

29. The method of claim 22 further comprising accepting said telephonic aural communication as one number that is entered by said at least one user to include said personal identification code and said transaction code.

30. The method of claim 22 wherein said arranging comprises arranging said at least one available transaction automatically in response to said accepting.

31. The method of claim 22 wherein said aural communication is a voice communication.

32. The method of claim 22 further comprising recognizing said personal identification code when said personal identification code is spoken in said aural voice communication, and wherein said accepting comprises accepting automatically said aural voice communication based on said recognizing.

33. The method of claim 22 wherein said registering at least one user comprises recording a signature of said at least one user speaking said personal identification code, said method further comprising comparing said signature with said personal identification code spoken in said aural voice communication, and said accepting comprising accepting automatically said aural voice communication based on said comparing.

34. The method of claim 22 wherein said at least one user is one of a plurality of registered users that each have a different user terminal platform and wherein said accepting comprises accepting aural communications from each of said different user terminal platforms.

35. The method of claim 22 wherein one of said two communications networks is a wireless communications network and the other one of said two communications networks is a public switched telephone network.

36. The method of claim 22 wherein said aural communication comprises dual-tone/multi-frequency entries.

37. The method of claim 22 further comprising registering one transaction that is available from said at least one user when said at least one user is registered.

38. The method of claim 22 further comprising registering at least one vendor of said at least one available transaction, said registering including recording payment information from each of said at least one vendor.

39. The method of claim 38 wherein said accepting comprises permitting said at least one registered vendor to request one of said at least one available transactions to be completed when said at least one vendor is registered.

40. The method of claim 22 wherein said registering at least one transaction comprises registering two transactions for two different locations, said assigning a transaction code comprises assigning to each of said two transactions said transaction code, said accepting comprising determining a location of said at least one user, and said method further comprising locating from where said communication is sent to identify one of said two transactions.

41. The method of claim 22 wherein said personal identification code is a unique identification code.

42. The method of claim 1 wherein said registering at least one user includes recording at least one telephone number of said at least one user, said method further comprising detecting a telephone number from which said aural communication originates, and said accepting includes verifying that said aural communication originates from one of said at least one recorded telephone numbers of said at least one user.

43. The method of claim 1 wherein said registering at least one user includes recording at least one communications address of said at least one user, said method further comprising detecting a communications address from which said aural communication originates, and said accepting includes verifying that said aural communication originates from one of said at least one recorded communications addresses of said at least one user.

44. The method of claim 1 wherein said registering at least one user comprises recording shipping information from each said at least one user, and said arranging comprises arranging for a shipment to be made based on said recorded shipping information.

45. The method of claim 1 further comprising confirming that said at least one user desires said at least one available transaction.

46. The method of claim 1 further comprising accepting said aural communication as one number that is entered by said at least one user to include said personal identification code and said transaction code.

47. The method of claim 1 wherein said arranging comprises arranging said at least one available transaction automatically in response to said accepting.

48. The method of claim 1 wherein said aural communication is a voice communication.

49. The method of claim 1 further comprising recognizing said personal identification code when said personal identification code is spoken in said aural voice communication, and wherein said accepting comprises accepting automatically said aural voice communication based on said recognizing.

50. The method of claim 1 wherein said registering at least one user comprises recording a signature of said at least one user speaking said personal identification code, said method further comprising comparing said signature with said personal identification code spoken in said aural voice communication, and said accepting comprising accepting automatically said aural voice communication based on said comparing.

51. The method of claim 1 wherein said at least one user is one of a plurality of registered users that each have a different user terminal platform and wherein said accepting comprises accepting aural communications from each of said different user terminal platforms.

52. The method of claim 1 wherein one of said two communications networks is a wireless communications network and the other one of said two communications networks is a public switched telephone network.

53. The method of claim 1 wherein said aural communication comprises dual-tone/multi-frequency entries.

54. The method of claim 1 further comprising registering one transaction that is available from said at least one user when said at least one user is registered.

55. The method of claim 1 further comprising registering at least one vendor of said at least one available transaction, said registering including recording payment information from each of said at least one vendor.

56. The method of claim 55 wherein said accepting comprises permitting said at least one registered vendor to request one of said at least one available transactions to be completed when said at least one vendor is registered.

57. The method of claim 1 wherein said at least one transaction comprises registering two transactions for two different locations, said assigning a transaction code comprises assigning to each of said two transactions said transaction code, said accepting comprising determining a location of said at least one user, and said method further comprising locating from where said communication is sent to identify one of said two transactions.

58. The method of claim 1 wherein said personal identification code is a unique identification code.

59. A transaction system comprising:
a registration processor for registering at least one available transaction, for assigning to said at least one available transaction a transaction code to be publicized, for registering at least one user, said registering at least one user including recording payment information from each said at least one user, and for assigning a personal identification code to each said at least one user; and
a transaction processor for accepting an aural communication from one of said at least one user including said personal identification code and said transaction code, and for arranging to have said at least one available transaction completed for said at least one user, including arranging to have payment collected based on said recorded payment information.

60. The system of claim 59 wherein said transaction processor is further for accepting automatically an aural communication from any one of at least two communications networks that each provide communications based on a different communications protocol.

61. The system of claim 60 further comprising a user communications interface for having said telephonic aural communication occur over a landline telephone.

62. The system of claim 60 further comprising a user communications interface for having said telephonic aural communication occur over a wireless telephone.

63. The system of claim 60 wherein said registration processor records at least one telephone number of said at least one user when said processor registers said at least one user, and said transaction processor detects a telephone number from which said telephonic aural communication originates, and is for verifying that said telephonic aural communication originates from one of said at least one recorded telephone numbers of said user.

64. The system of claim 60 wherein said registration processor records at least one communications address of said at least one user when said registration processor registers said at least one user, and said transaction processor is further for detecting a communications address from which said telephonic aural communication originates, and is for verifying that said telephonic aural communication originates from one of said at least one recorded communications addresses of said at least one user.

65. The system of claim 60 wherein said registration processor records shipping information from each said at least one user when said registration processor registers said at least one user, and said transaction processor arranges a shipment to be made based on said recorded shipping information.

66. The system of claim 60 wherein said transaction processor confirms that said at least one user desires said at least one available transaction.

67. The system of claim 60 wherein said transaction processor accepts said telephonic aural communication as one number that is entered by said at least one user to include said personal identification code and said transaction code.

68. The system of claim 60 wherein said transaction processor automatically completes said at least one available transaction in response to said telephonic aural communication being accepted.

69. The system of claim 60 wherein said aural communication is a voice communication.

70. The system of claim 60 further comprising a voice analyzer for recognizing said personal identification code when said personal identification code is spoken in said aural voice communication, and wherein said transaction processor accepts said aural voice communication based on said recognizing said personal identification code.

71. The system of claim 60 wherein registration processor records a signature of said at least one user speaking said personal identification code, said system further comprising a voice analyzer for comparing said signature with said personal identification code spoken in said aural voice communication, and transaction processor accepts said aural voice communication based on said comparing said persona identification code.

72. The system of claim 60 wherein said transaction processor accepts aural communications from a plurality of said at least one user that each have a different user terminal having a different user terminal platform.

73. The system of claim 60 wherein one of said two communications networks is a wireless communications network and the other one of said two communications networks is a public switched telephone network.

74. The system of claim 60 wherein said aural communication comprises dual-tone/multi-frequency entries.

75. The system of claim 60 wherein said registration processor comprises registering one transaction that is available from said at least one user when said at least one user is registered.

76. The system of claim 60 wherein said registration processor registers at least one vendor of said at least one available transaction includes recording payment information from each of said at least one vendor.

77. The system of claim 76 wherein said transaction processor permits said at least one registered vendor to request one of said at least one available transactions to be completed when said at least one vendor is registered.

78. The system of claim 60 wherein said registration processor registers two transactions for two different locations, assigns to each of said two transactions said transaction code, and said system further comprising a user locator for determining a location of said at least one user, and said transaction processor locates from where said communication is sent to identify one of said two transactions.

79. The system of claim 60 wherein said personal identification code is a unique identification code.

80. The system of claim 59 wherein said aural communication is telephonic.

81. The system of claim 80 further comprising a user communications interface for having said telephonic aural communication occur over a landline telephone.

82. The system of claim 80 further comprising a user communications interface for having said telephonic aural communication occur over a wireless telephone.

83. The system of claim 80 wherein said registration processor records at least one telephone number of said at least one user when said processor registers said at least one user, and said transaction processor detects a telephone number from which said telephonic aural communication originates, and is for verifying that said telephonic aural communication originates from one of said at least one recorded telephone numbers of said user.

84. The system of claim 80 wherein said registration processor records at least one communications address of said at least one user when said registration processor registers said at least one user, and said transaction processor is further for detecting a communications address from which said telephonic aural communication originates, and is for verifying that said telephonic aural communication originates from one of said at least one recorded communications addresses of said at least one user.

85. The system of claim 80 wherein said registration processor records shipping information from each said at least one user when said registration processor registers said at least one user, and said transaction processor arranges a shipment to be made based on said recorded shipping information.

86. The system of claim 80 wherein said transaction processor confirms that said at least one user desires said at least one available transaction.

87. The system of claim 80 wherein said transaction processor accepts said telephonic aural communication as one number that is entered by said at least one user to include said personal identification code and said transaction code.

88. The system of claim 80 wherein said transaction processor automatically completes said at least one available transaction in response to said telephonic aural communication being accepted.

89. The system of claim 80 wherein said aural communication is a voice communication.

90. The system of claim 80 further comprising a voice analyzer for recognizing said personal identification code when said personal identification code is spoken in said aural voice communication, and wherein said transaction processor accepts said aural voice communication based on said recognizing said personal identification code.

91. The system of claim 80 wherein registration processor records a signature of said at least one user speaking said personal identification code, said system further comprising a voice analyzer for comparing said signature with said personal identification code spoken in said aural voice communication, and transaction processor accepts said aural voice communication based on said comparing said persona identification code.

92. The system of claim 80 wherein said transaction processor accepts aural communications from a plurality of said at least one user that each have a different user terminal having a different user terminal platform.

93. The system of claim 80 wherein one of said two communications networks is a wireless communications network and the other one of said two communications networks is a public switched telephone network.

94. The system of claim 80 wherein said aural communication comprises dual-tone/multi-frequency entries.

95. The system of claim 80 wherein said registration processor comprises registering one transaction that is available from said at least one user when said at least one user is registered.

96. The system of claim 80 wherein said registration processor registers at least one vendor of said at least one available transaction includes recording payment information from each of said at least one vendor.

97. The system of claim 96 wherein said transaction processor permits said at least one registered vendor to request one of said at least one available transactions to be completed when said at least one vendor is registered.

98. The system of claim 80 wherein said registration processor registers two transactions for two different locations, assigns to each of said two transactions said transaction code, and said system further comprising a user locator for determining a location of said at least one user, and said transaction processor locates from where said communication is sent to identify one of said two transactions.

99. The system of claim 80 wherein said personal identification code is a unique identification code.

100. The system of claim 59 wherein said registration processor records at least one telephone number of said at least one user when said processor registers said at least one user, and said transaction processor detects a telephone number from which said aural communication originates, and is for verifying that said aural communication originates from one of said at least one recorded telephone numbers of said at least one user.

101. The system of claim 59 wherein said registration processor records at least one communications address of said user when said registration processor registers said at least one user, and said transaction processor detects a communications address from which said aural communication originates, and is for verifying that said aural communication originates from one of said at least one recorded communications addresses of said at least one user.

102. The system of claim 59 wherein said registration processor records shipping information from each said at least one user when said registration processor registers said at least one user, and said transaction processor arranges for a shipment to be made based on said recorded shipping information.

103. The system of claim 59 wherein said transaction processor confirms that said at least one user desires said at least one available transaction.

104. The system of claim 59 wherein said transaction processor accepts said aural communication as one number that is entered by said at least one user to include said personal identification code and said transaction code.

105. The system of claim 59 wherein said transaction processor automatically arranges said at least one available transaction in response to said aural communication being accepted.

106. The system of claim 59 wherein said aural communication is a voice communication.

107. The system of claim 59 further comprising a voice analyzer for recognizing said personal identification code when said personal identification code is spoken in said aural voice communication, and wherein said transaction processor accepts said aural voice communication based on said recognizing said personal identification code.

108. The system of claim 59 wherein registration processor records a signature of said at least one user speaking said personal identification code, said system further comprising a voice analyzer for comparing said signature with said personal identification code spoken in said aural voice communication, and transaction processor accepts said aural voice communication based on said comparing said persona identification code.

109. The system of claim 59 wherein said transaction processor accepts aural communications from a plurality of said at least one user that each have a different user terminal having a different user terminal platform.

110. The system of claim 59 wherein one of said two communications networks is a wireless communications network and the other one of said two communications networks is a public switched telephone network.

111. The system of claim 59 wherein said aural communication comprises dual-tone/multi-frequency entries.

112. The system of claim 59 wherein said registration processor comprises registering one transaction that is available from said at least one user when said at least one user is registered.

113. The system of claim 59 wherein said registration processor registers at least one vendor of said at least one available transaction includes recording payment information from each of said at least one vendor.

114. The system of claim 113 wherein said transaction processor permits said at least one registered vendor to request one of said at least one available transactions to be completed when said at least one vendor is registered.

115. The system of claim 59 wherein said registration processor registers two transactions for two different locations, assigns to each of said two transactions said transaction code, and said system further comprising a user locator for determining a location of said at least one user, and said transaction processor locates from where said communication is sent to identify one of said two transactions.

116. The system of claim 59 wherein said personal identification code is a unique identification code.

117. A transaction system comprising:
means for registering at least one available transaction;
means for assigning to said at least one available transaction a transaction code to be publicized;
means for registering at least one user, said registering including recording payment information from each said at least one user;
means for assigning a personal identification code to each said at least one user;
means for accepting an aural communication from one of said at least one user including said personal identification code and said transaction code; and
means for arranging said at least one available transaction to be completed for said at least one user, including arranging to have payment collected based on said recorded payment information.

118. The system of claim 117 wherein said means for accepting comprises means for accepting automatically an aural communication from any one of at least two communications networks that each provide communications based on a different communications protocol.

119. The system of claim 118 wherein said means for accepting comprises means for having said telephonic aural communication occur over a landline telephone.

120. The system of claim 118 wherein said means for accepting comprises means for having said telephonic aural communication occur over a wireless telephone.

121. The system of claim 118 wherein said means for registering said at least one user includes means for recording at least one telephone number of said at least one user, said system further comprising means for detecting a telephone number from which said telephonic aural communication originates, and said means for accepting includes means for verifying that said telephonic aural communication originates from one of said at least one recorded telephone numbers of said at least one user.

122. The system of claim 118 wherein said means for registering at least one user includes means for recording at least one communications address of said at least one user, said system further comprising means for detecting a communications address from which said telephonic aural communication originates, and said means for accepting includes means for verifying that said telephonic aural communication originates from one of said at least one recorded communications addresses of said at least one user.

123. The system of claim 118 wherein said means for registering at least one user comprises means for recording shipping information from each said at least one user, and said means for arranging comprises means for arranging a shipment to be made based on said recorded shipping information.

124. The system of claim 118 further comprising means for confirming that said at least one user desires said at least one available transaction.

125. The system of claim 118 further comprising means for accepting said aural communication as one number that is entered by said at least one user to include said personal identification code and said transaction code.

126. The system of claim 118 wherein said means for completing comprises means for automatically arranging said at least one available transaction in response to said means for accepting.

127. The system of claim 118 wherein said aural communication is a voice communication.

128. The system of claim 118 further comprising means for recognizing said personal identification code when said personal identification code is spoken in said aural voice communication, and wherein said means for accepting comprises means for accepting said aural voice communication based on said recognizing.

129. The system of claim 118 wherein said means for registering at least one user comprises means for recording a signature of said at least one user speaking said personal identification code, said system further comprising means for comparing said signature with said personal identification code spoken in said aural voice communication, and said means for accepting comprising means for accepting said aural voice communication based on comparing said personal identification code and said signature.

130. The system of claim 118 wherein said means for accepting comprises means for accepting aural communications from each one of a plurality of said at least one user that each have a different user terminal platform.

131. The system of claim 118 wherein one of said two communications networks is a wireless communications network and the other one of said two communications networks is a public switched telephone network.

132. The system of claim 118 wherein said aural communication comprises dual-tone/multi-frequency entries.

133. The system of claim 118 further comprising means for registering one transaction that is available from said at least one user when said at least one user is registered.

134. The system of claim 118 further comprising means for registering at least one vendor of said at least one available transaction, said means for registering at least one vendor comprising means for recording payment information from each of said at least one vendor.

135. The system of claim 94 wherein said means for accepting comprises means for permitting said at least one registered vendor to request one of said at least one available transactions to be completed for said at least one registered vendor with another vendor.

136. The system of claim 118 wherein said means for registering at least one transaction comprises means for registering two transactions for two different locations, said means for assigning a transaction code comprises means for assigning to each of said two transactions said transaction code, said means for accepting comprising means for determining a location of said at least one user, and said system further comprising means for locating from where said communication is sent to identify one of said two transactions.

137. The system of claim 118 wherein said personal identification code is a unique identification code.

138. The system of claim 117 wherein said aural communication is telephonic.

139. The system of claim 138 wherein said means for accepting comprises means for having said telephonic aural communication occur over a landline telephone.

140. The system of claim 138 wherein said means for accepting comprises means for having said telephonic aural communication occur over a wireless telephone.

141. The system of claim 138 wherein said means for registering said at least one user includes means for recording at least one telephone number of said at least one user, said system further comprising means for detecting a telephone number from which said telephonic aural communication originates, and said means for accepting includes means for verifying that said telephonic aural communication originates from one of said at least one recorded telephone numbers of said at least one user.

142. The system of claim 138 wherein said means for registering at least one user includes means for recording at least one communications address of said at least one user, said system further comprising means for detecting a communications address from which said telephonic aural communication originates, and said means for accepting includes means for verifying that said telephonic aural communication originates from one of said at least one recorded communications addresses of said at least one user.

143. The system of claim 138 wherein said means for registering at least one user comprises means for recording shipping information from each said at least one user, and said means for arranging comprises means for arranging a shipment to be made based on said recorded shipping information.

144. The system of claim 138 further comprising means for confirming that said at least one user desires said at least one available transaction.

145. The system of claim 138 further comprising means for accepting said aural communication as one number that is entered by said at least one user to include said personal identification code and said transaction code.

146. The system of claim 138 wherein said means for completing comprises means for automatically arranging said at least one available transaction in response to said means for accepting.

147. The system of claim 138 wherein said aural communication is a voice communication.

148. The system of claim 138 further comprising means for recognizing said personal identification code when said personal identification code is spoken in said aural voice communication, and wherein said means for accepting comprises means for accepting said aural voice communication based on said recognizing.

149. The system of claim 138 wherein said means for registering at least one user comprises means for recording a signature of said at least one user speaking said personal identification code, said system further comprising means for comparing said signature with said personal identification code spoken in said aural voice communication, and said means for accepting comprising means for accepting said aural voice communication based on comparing said personal identification code and said signature.

150. The system of claim 138 wherein said means for accepting comprises means for accepting aural communications from each one of a plurality of said at least one user that each have a different user terminal platform.

151. The system of claim 138 wherein one of said two communications networks is a wireless communications network and the other one of said two communications networks is a public switched telephone network.

152. The system of claim 138 wherein said aural communication comprises dual-tone/multi-frequency entries.

153. The system of claim 138 further comprising means for registering one transaction that is available from said at least one user when said at least one user is registered.

154. The system of claim 138 further comprising means for registering at least one vendor of said at least one available transaction, said means for registering at least one vendor comprising means for recording payment information from each of said at least one vendor.

155. The system of claim 154 wherein said means for accepting comprises means for permitting said at least one registered vendor to request one of said at least one available transactions to be completed for said at least one registered vendor with another vendor.

156. The system of claim 138 wherein said means for registering at least one transaction comprises means for registering two transactions for two different locations, said means for assigning a transaction code comprises means for assigning to each of said two transactions said transaction code, said means for accepting comprising means for determining a location of said at least one user, and said system further comprising means for locating from where said communication is sent to identify one of said two transactions.

157. The system of claim 138 wherein said personal identification code is a unique identification code.

158. The system of claim 117 wherein said means for registering said at least one user includes means for recording at least one telephone number of said at least one user, said system further comprising means for detecting a telephone number from which said aural communication originates, and said means for accepting includes means for verifying that said aural communication originates from one of said at least one recorded telephone numbers of said at least one user.

159. The system of claim 117 wherein said means for registering at least one user includes means for recording at least one communications address of said at least one user, said system further comprising means for detecting a communications address from which said aural communication originates, and said means for accepting includes means for verifying that said aural communication originates from one of said at least one recorded communications addresses of said at least one user.

160. The system of claim 117 wherein said means for registering at least one user comprises means for recording shipping information from each said at least one user, and said means for arranging comprises means for arranging a shipment to be made based on said recorded shipping information.

161. The system of claim 117 further comprising means for confirming that said at least one user desires said at least one available transaction.

162. The system of claim 117 further comprising means for accepting said aural communication as one number that is entered by said at least one user to include said personal identification code and said transaction code.

163. The system of claim 117 wherein said means for arranging comprises means for automatically completing said at least one available transaction in response to said means for accepting.

164. The system of claim 117 wherein said aural communication is a voice communication.

165. The system of claim 117 further comprising means for recognizing said personal identification code when said personal identification code is spoken in said aural voice communication, and wherein said means for accepting comprises means for accepting said aural voice communication based on said recognizing.

19. The system of claim 117 wherein said means for registering at least one user comprises means for recording a signature of said at least one user speaking said personal identification code, said system further comprising means for comparing said signature with said personal identification code spoken in said aural voice communication, and said means for accepting comprising means for accepting said aural voice communication based on comparing said personal identification code and said signature.

166. The system of claim 117 wherein said means for accepting comprises means for accepting aural communications from each one of a plurality of said at least one user that each have a different user terminal platform.

167. The system of claim 117 wherein one of said two communications networks is a wireless communications network and the other one of said two communications networks is a public switched telephone network.

168. The system of claim 117 wherein said aural communication comprises dual-tone/multi-frequency entries.

169. The system of claim 117 further comprising means for registering one transaction that is available from said at least one user when said at least one user is registered.

170. The system of claim 117 further comprising means for registering at least one vendor of said at least one available transaction, said means for registering at least one vendor comprising means for recording payment information from each of said at least one vendor.

171. The system of claim 170 wherein said means for accepting comprises means for permitting said at least one registered vendor to request one of said at least one available transactions to be completed for said at least one registered vendor with another vendor.

172. The system of claim 117 wherein said means for registering at least one transaction comprises means for registering two transactions for two different locations, said means for assigning a transaction code comprises means for assigning to each of said two transactions said transaction code, said means for accepting comprising means for determining a location of said at least one user, and said system further comprising means for locating from where said communication is sent to identify one of said two transactions.

173. The system of claim 117 wherein said personal identification code is a unique identification code.
